(19) United States
(12) Patent Application Publication
(10) Pub. No.: US 2016/0061463 A1
(43) Pub. Date: Mar. 3, 2016

(54) Motor Vehicle Interior Passive Environmental Moderator

(71) Applicant: Thomas M. Adams, San Antonio, TX (US)

(72) Inventor: Thomas M. Adams, San Antonio, TX (US)

(21) Appl. No.: 14/842,765

(22) Filed: Sep. 1, 2015

Related U.S. Application Data
(63) Continuation-in-part of application No. 13/874,455, filed on Apr. 30, 2013, now Pat. No. 9,121,621.
(60) Provisional application No. 61/640,543, filed on Apr. 30, 2012.

(51) Int. Cl. F24F 6/08; B60H 3/02

(52) U.S. Cl. CPC F24F 6/08; B60H 3/022

(57) ABSTRACT

A structured mat that is placed on an automobile's dashboard (and/or the rear window shelf) and provided with a quantity of water, or other suitable liquid, that on heating will evaporate into the interior air of the vehicle. The mat structure includes a water impermeable layer that lays against and partially covers the top surface of the dashboard and/or rear shelf and a fluid wicking layer over the impermeable layer that may be saturated with evaporative fluid (on a repeated basis as necessary) and serve as a reservoir for the evaporative process to be carried out. The multilayered surface may be manually refilled with water (or other suitable liquid) from a hand held container or may be automatically refilled from reservoirs structured in fluid connection to the evaporative surface.

### CROSS REFERENCES TO RELATED APPLICATIONS

This application claims the benefit under 35 U.S.C. §120 of co-pending U.S. patent application Ser. No. 13/874,455, filed Apr. 30, 2013; which further claims the benefit under 35 U.S.C. §119(e) of U.S. Provisional Application 61/640,543 filed Apr. 30, 2012, the full disclosures of which are incorporated herein by reference.

### BACKGROUND OF THE INVENTION

1. Field of the Invention

The present invention relates generally to automotive products and accessories. The present invention relates more specifically to a passive system for evaporative cooling and humidifying of the interior of an automobile or a truck.

2. Description of the Related Art

Whenever the sun's rays penetrate the windshield of an automobile, whether the vehicle is parked or in motion, the dashboard accumulates heat, at times to a degree that the surface of the dashboard is not touchable. Similar effects occur through most angled rear windows positioned over the generally horizontal rear shelf immediately behind the rear seats in many vehicles. Air conditioning provides cooling to the interior of the vehicle, but as long as the sun's rays are striking the dashboard and/or the rear window shelf, even with the air conditioner on full, these sunlit horizontal surfaces (the dashboard and the rear window shelf) absorb and retain a significant amount of heat that, in turn, continues to subvert the effectiveness of the air conditioning system.

In addition, air conditioning systems withdraw moisture from the air that is being cooled, causing the interior air of the vehicle to become inordinately dry, a situation that is usually not consciously adverted to, but once pointed out, becomes all too noticeable as contributing to discomfort and fatigue. The combination of the air conditioner working harder to cool the air as it confronts the ongoing dashboard-created heat, and the resulting dryness of the air, can lead to dehydration of the occupants of the vehicle, accelerate fatigue, and dry out the mucous membranes of the nose and mouth of each occupant. Most people remark of fatigue at the end of a long trip, a fatigue that is noticeably more severe after traveling on a sunny day.

It would be beneficial to have a device that would passively (without the need for electrical power or the need to draw energy from the engine of the vehicle) put moisture into the air within a vehicle. It would be beneficial if this could occur both while the vehicle is stationary (without the engine or air conditioner running) and when the vehicle is in motion (when the vehicle heater or air conditioner is removing moisture from the air). It would be desirable if such a device could function as a reaction to the heat absorption that readily occurs through the windshield and/or the rear window in a vehicle. It would further be desirable if such a device were easy to install, easy to remove, easy to maintain, and easy to clean when necessary.

### SUMMARY OF THE INVENTION

In fulfillment of the above and further objectives the present invention provides for a structured cover that is placed on an automobile's dashboard (and/or the rear window shelf) and provided with a quantity of water, or other suitable liquid, that on heating will evaporate into the interior air of the vehicle. With such a cover, the heat of the sun's rays will do two things that add to the comfort of the occupants of a closed vehicle that is equipped with an air conditioning system that is in operation. First, the heat of the sun's rays will cause the water in/on the cover to evaporate slowly and continuously, thus cooling the dashboard (and/or rear window shelf) while creating moisture to moderate the dryness of the interior air. Second, some of that moisture will be condensed by the air conditioner, a process that will increase the effectiveness of the air conditioning operation. The device includes a water impermeable layer that lays against and partially covers the top surface of the dashboard and/or rear shelf and a water wicking layer over the impermeable layer that may be saturated with water (on a repeated basis as necessary) and serve as a reservoir for the evaporative process to be carried out. This open pad or mat may preferably be shaped to fit various dashboards and rear window shelves. Alternate embodiments allow the user to customize the shape and size of the pad. The multilayered surface may be manually refilled with water (or other suitable liquid) from a hand held container or may be automatically refilled from reservoirs structured in fluid connection to the evaporative surface.

### BRIEF DESCRIPTION OF THE DRAWINGS

FIG. 1 is a perspective view of a typical automobile dashboard with a preferred embodiment of the passive humidifier.

FIG. 2 is a cross-sectional view of a first preferred embodiment of the present invention.

FIG. 3 is a cross-sectional view of a second preferred embodiment of the present invention.

FIGS. 4A & 4B are top plan and cross-sectional views of a further alternate embodiment of the present invention.

FIG. 5A is a top plan view of an alternate preferred embodiment of the front dashboard component of the system of the present invention.

FIG. 5B is a cross sectional view of the alternate preferred embodiment shown in FIG. 5A taken along section line B-B′.

FIG. 6A is a detailed top plan view of an alternate retention element for the front dashboard component shown in FIG. 5A.

FIG. 6B is a partial cross sectional side view of the retention element shown in FIG. 6A.

FIG. 7 is a detailed top plan view of a further alternate retention element for the front dashboard component shown in FIG. 5A.

FIG. 8 is a detailed top plan view of a further alternate retention element for the front dashboard component shown in FIG. 5A.

FIG. 9A is a top plan view of an alternate embodiment for a rear window shelf component of the system of the present invention.

FIG. 9B is a cross sectional view of the rear window shelf component shown in FIG. 9A taken along section line C-C′.

FIG. 10 is an assembly view showing a kit of components for implementation of the system of the present invention within a single motor vehicle, providing a front dashboard component and a rear window shelf component.

FIGS. 11A-11C are top plan views of additional alternate embodiments of the present invention manufactured into the original dashboard structure of an automobile.

### DETAILED DESCRIPTION OF THE PREFERRED EMBODIMENTS

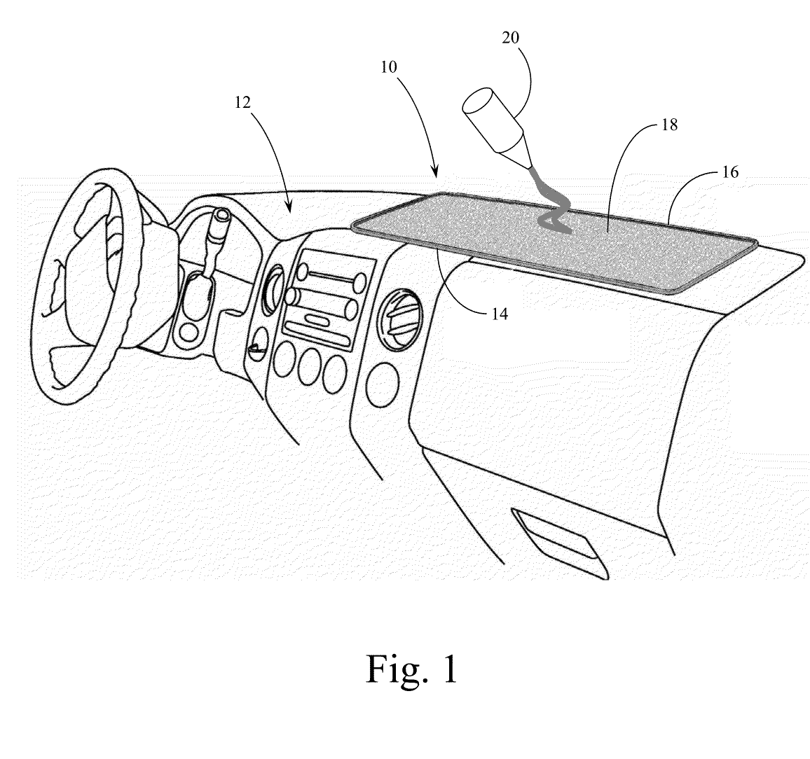

Reference is made first to FIG. 1 which is a perspective view of a typical automobile dashboard showing the placement of a first preferred embodiment of the passive humidifier of the present invention. The components and structures associated with implementation of the present invention in conjunction with the front dashboard of a vehicle are equally applicable to implementation on other generally horizontal surfaces within the vehicle, such as rear window shelves and sills. Passive humidifier 10 is shown positioned on a standard sized automobile dashboard 12 and includes a slip resistant base 14 and a wicking, water impervious fabric 18. Fabric 18 is preferably a material that in a woven or sponge state can receive, hold, and wick water through the material without dissolving or otherwise degrading the material. Any of a number of polymer woven fabrics or porous solids materials can provide the necessary balance of characteristics that allow for retention of water and its evaporation by wicking action.

The fabric 18 may preferably be constructed with a raised edge 16 to prevent moisture from seeping off of the fabric material 18. Water, such as from a dispensing bottle 20 is placed onto fabric 18 where it is held within the fabric material 18 on top of the waterproof base 14 surrounded by the raised edge 16. In this manner, a quantity of water may be subjected to the sun's rays and absorb the heat thereof so as to evaporate into the interior of the automobile. As indicated above, this process of evaporation facilitates the comfort of the occupants of the vehicle.

Placement, removal, and maintenance of the device of the present invention is made easy by its convenient accessibility. In addition, optimal placement of the device is well removed from any chance of interference with other components and functions of the typical dashboard, such as airbags on the front or sensors near the windshield. Other elements on the dashboard or rear window shelf (such as speakers, etc.) may be accommodated by custom shapes and sizes or by use of the customizable configuration of the device described in more detail below.

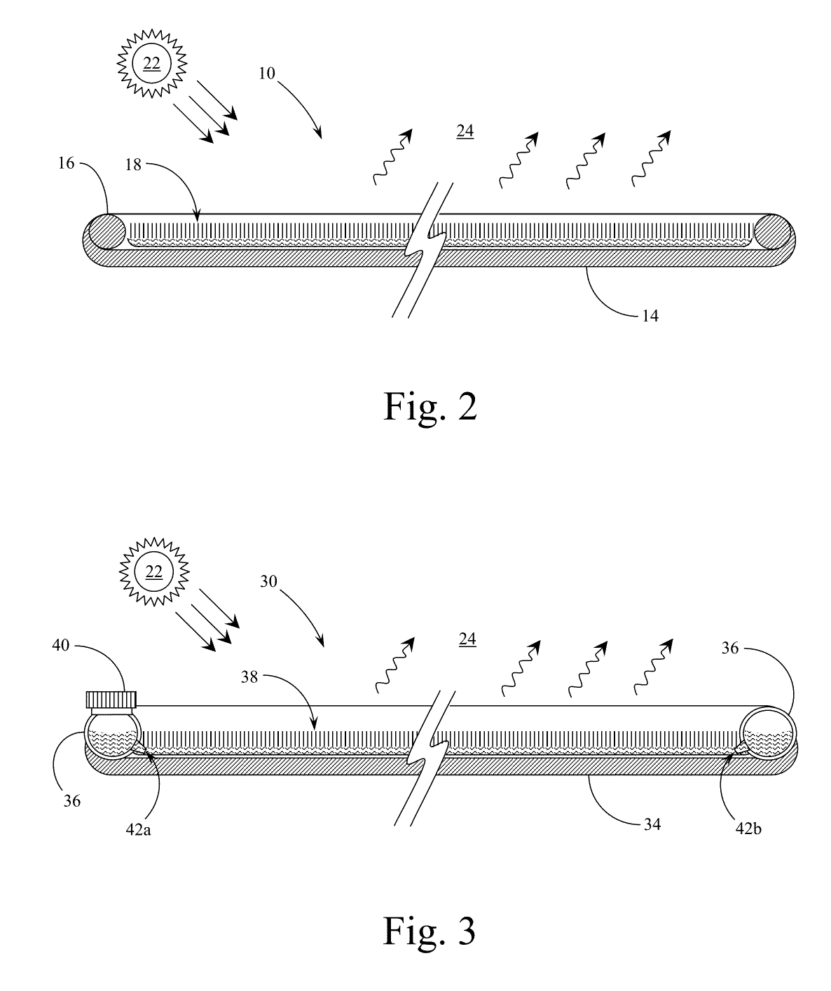

FIG. 2 is a partial cross-sectional view of a first preferred embodiment of the present invention showing the arrangement of layers in the passive humidifier cover and the manner in which the sun's rays may cause evaporation of water held within the cover. In FIG. 2, passive humidifier 10 is shown to be made up of slip resistant bottom 14 which is preferably a water impermeable sheet having a perimeter raised edge 16 (also water impermeable) that allows a generous quantity of water to be retained within the confines of the cover. The sun's energy 22 falls on passive humidifier 10 and is absorbed by the moisture present in the wicking fabric 18 positioned over the top of base 14. By absorbing heat, the water in the wicking fabric 18 turns to vapor 24, and as described above, facilitates both the cooling of the dashboard and humidifying the air for the comfort of the vehicle occupants.

FIG. 3 is a cross-sectional view of an alternate preferred embodiment of the present invention wherein a supply of water may be provided to the passive humidifier so as to reduce the frequency with which additional water must be added. Passive humidifier cover 30 shown in FIG. 3 again retains a waterproof slip resistant bottom 34 on top of which is positioned wicking fabric 38 into which water is drawn for the purposes of being heated and evaporated as described above. In the second embodiment shown in FIG. 3, the raised perimeter edge is replaced with a tubular reservoir 36 that retains a quantity of water that may be drawn into impervious fabric 38 through seepage ports 42a & 42b as shown. Various seepage ports may be constructed through the walls of the tubular water reservoir 36 that forms the perimeter edge of the cover. The water reservoir may be refilled through an opening under removable cap 40 positioned at one location on water reservoir 36.

The dashboard moderator cover of the present invention should be made of a material that has a wicking property. The cover may be made in two or more sizes so as to fit a wide variety of vehicles and have a means of keeping the cover in place (non-slip) on the dashboard. (Manufacturers of automobiles could integrate the cover into the design of the dashboard.) The water coolant, or an alternative appropriate liquid, may be delivered to, and/or through, the dashboard cover either externally by using a spray bottle, or internally from a built-in vessel with a dispersant means as described above.

Although water would be the preferred primary ingredient in the fluid to be evaporated with the device of the present invention various additives may be mixed in to serve additional functions. A disinfectant and/or antibacterial compound may be added to the fluid to inhibit the growth of bacterial (in the moist environment of the device) and reduce the need to periodically clean the device between uses. A fragrance compound may be added to instill a fragrant smell into the air, carried with the evaporation of the water. Antifogging agents and other beneficial but non-toxic and non-irritating compounds may further be added to the evaporative fluid.

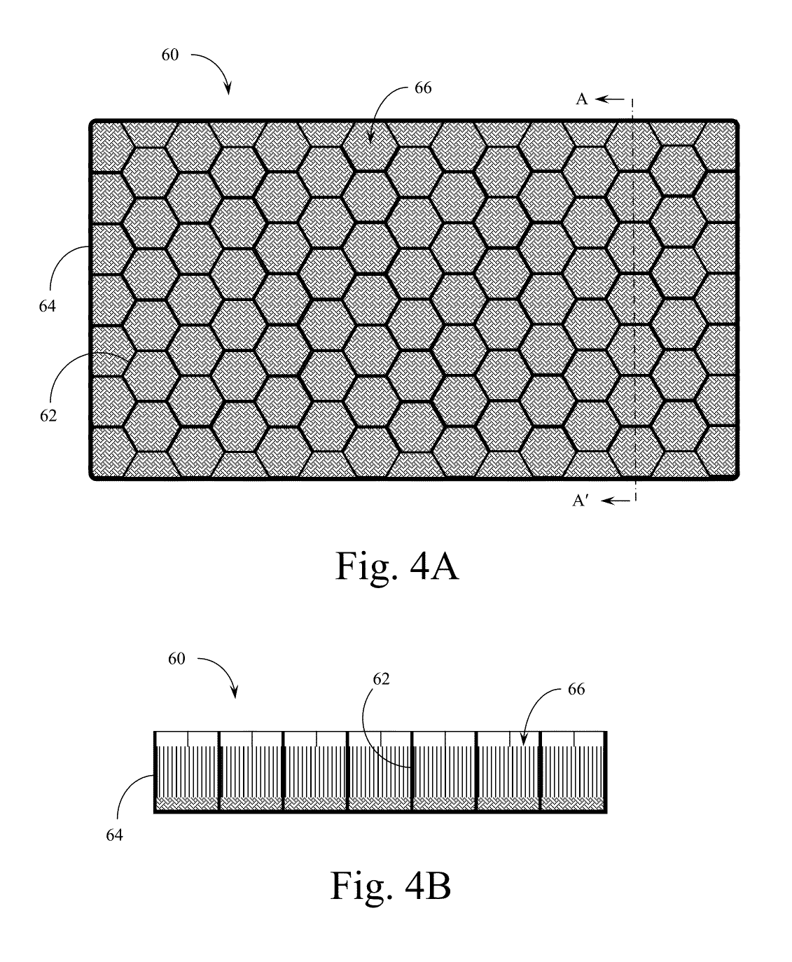

FIGS. 4A & 4B are top plan and cross-sectional views of a further alternate embodiment of the present invention. In this simplified embodiment passive humidifier 60 is constructed of a sheet of cells 62 that allow the pad to be cut by the user to customize the fit. Each cell 62 holds a section 66 of wicking fabric or wicking material as described above, albeit not in fluid communication with the entire mat or pad. The entire pad or pad section may initially include an outer wall 64, and multiple pads may be positioned adjacent each other and trimmed as necessary to provide a custom fit. One downside to this construction is the inability to refill the humidifier at a single point as water would need to be poured or sprayed over and into the multiple cells. In addition it would be difficult to implement the automatic refill reservoir system described above. Nonetheless, there may be situations where customization of the humidifier, either by placement of multiple pads and/or the trimming of a pad to fit, might be beneficial.

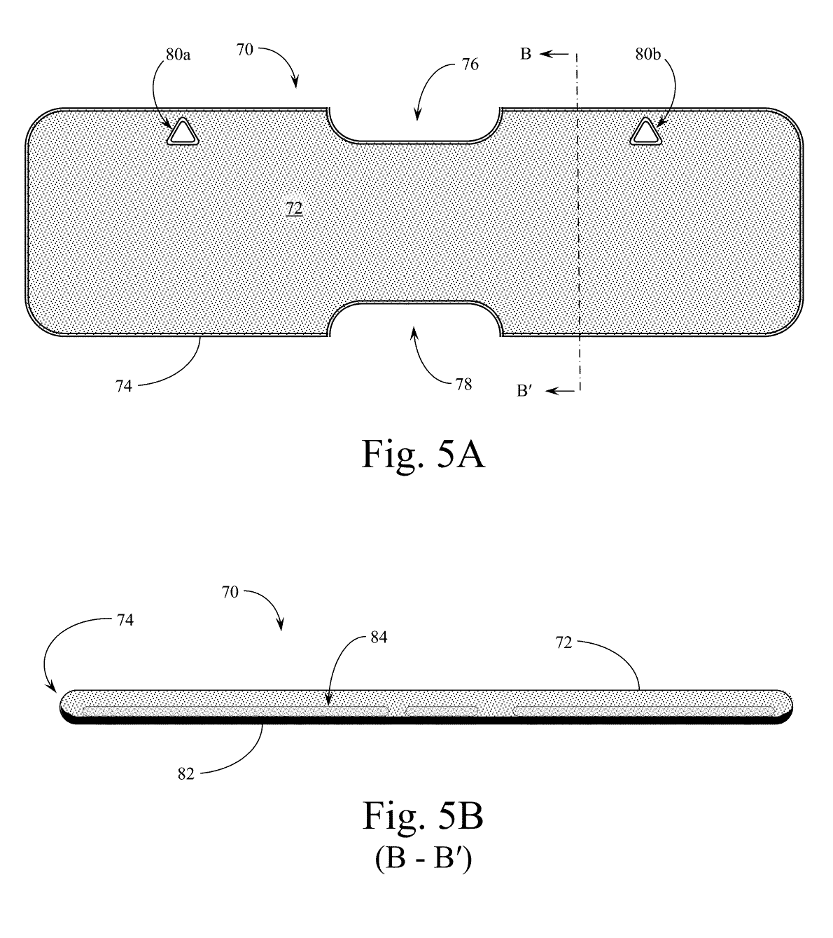

Reference is next made to FIGS. 5A & 5B for a detailed description of an alternate preferred embodiment of the front dashboard component of the system of the present invention. Front dashboard mat 70 is shaped to accommodate various features typically associated with automotive dashboards. While the basic construction of mat 70 is the same as in previous embodiments, being essentially constructed of a layer of wicking or evaporative material 72, in this embodiment there is no raised perimeter edge, functioning instead with a simple finished edge 74. In addition, cutouts 76 & 78 are formed in mat 70 to accommodate a rise in the dashboard for placement of instrument displays (cutout 78) or to accommodate various dashboard sensor elements that face towards the front through the windshield (cutout 76). In addition, mat 70 incorporates two retention apertures surrounded by retention grommets 80a & 80b. The embodiment shown in FIG. 5A incorporates triangular grommets 80a & 80b in order to facilitate the positioning and centering of mat 70.

The dimensions of mat 70 shown in FIG. 5A are intended to accommodate the most common sized front dashboards in automotive vehicles. The product marketed in the configuration shown in FIG. 5A is long enough to accommodate the widest dashboards with the mat capable of being folded under at each end to reduce the overall length by as much as eight to ten inches so as to accommodate shorter (side to side in the vehicle) lengths of dashboard.

FIG. 5B shows a cross sectional view taken along section line B-B′ in FIG. 5A. Mat 70 in this view is shown to primarily comprise the fibrous evaporative sheet of material 72 finished at its edges 74 by simply cutting and heat fusing, or by creating a stitched edging primarily for aesthetic purposes. The nature of the fibrous material utilized for mat 70 is such that as long as excessive amounts of fluid are not placed into the mat, there is no need to provide a separate retention perimeter to hold the fluids in. Various types of non-woven pressed fiber (natural or synthetic) sheet materials are suitable for the fluid retention and evaporation functions of the present invention. Many such current materials incorporate microcapsule phase change materials (PCM) that enhance the heat transfer capabilities of the layer.

On the underside of mat 70 a fluid impermeable layer 82 is placed in order to readily retain fluid 84 within the fibrous structure of evaporative material 72. Impermeable layer 82 may be a layer of cured silicon-based sealant applied to the underside of the fibrous evaporative layer such that it is partially absorbed into the fibers to form a seal across the entire base of the mat. Various silicon-based compounds may be applied and allowed to cure to form a completely closed surface on the bottom of the mat in order to prevent the passage of fluid through from the top of the mat. The thickness of the sealing layer need not be large in comparison to the wicking layer and therefore should not significantly reduce the volume of fluid that the evaporative material layer can retain. Spray-on type waterproof compounds may also be utilized such as waterproofing products marketed under the Scotchgard® brand.

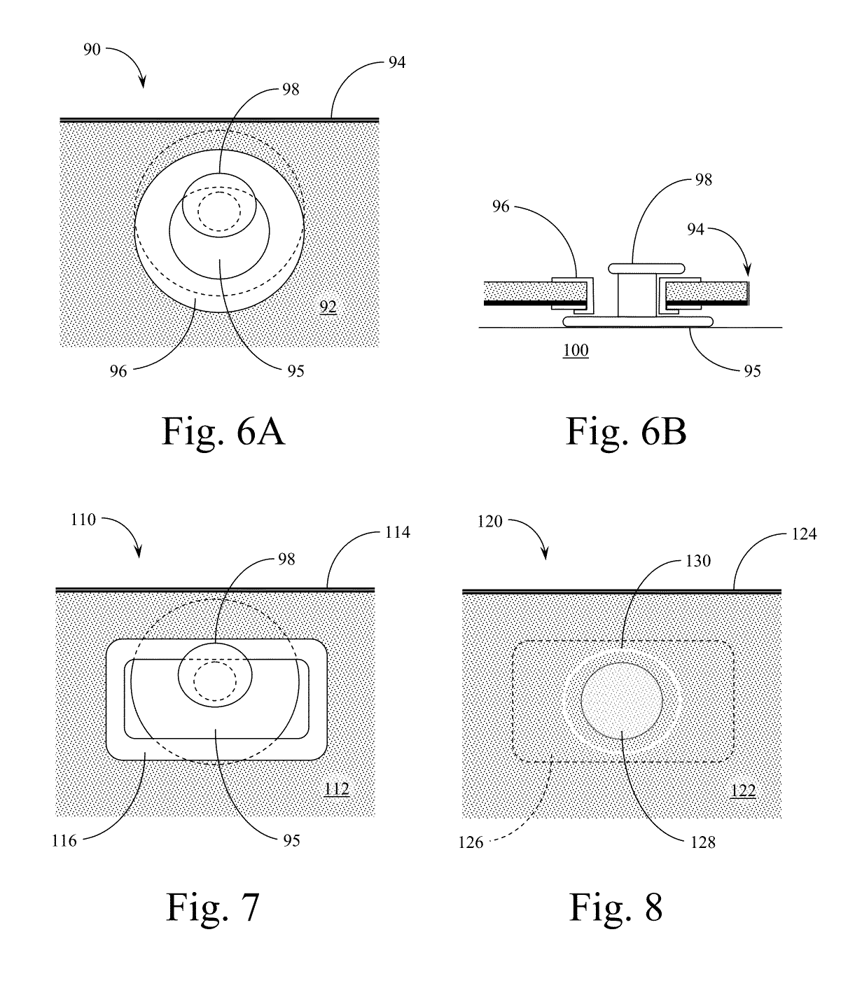

Reference is next made to FIGS. 6A & 6B which show one type of retention mechanism for positioning and retaining the front mat of the present invention on the dashboard surface. While triangular grommets 80a & 80b are shown in FIG. 5A, FIG. 6A shows the use of a circular grommet 96 in the same manner. Front dashboard mat 90 with evaporative material 92 and finished edge 94 has positioned through all layers of the mat, a grommet 96 that is sized and positioned to be placed over a previously installed retention post 98. Retention post 98 (seen best in FIG. 6B) comprises a base 95 that is adhered to the dashboard surface 100, preferably using a moderately strong adhesive. Orienting retention post 98 towards the front of the vehicle to form a hook onto which the grommet may catch, comprises placing the deeper slot on post 98 towards the front. In this manner when grommet 96 is placed over retention post 98 it may slide back and thereby be retained under the cap portion of retention post 98.

FIG. 7 shows a further alternate embodiment of the retention mechanism wherein front dashboard mat 110, having evaporative material 112 and finished edge 114, incorporates a rectangular grommet 116 that provides a larger opening to receive retention post 98. This rectangular grommet structure provides somewhat greater leeway in the accurate placement of the retention posts on the dashboard surface.

FIG. 8 shows a further alternate mechanism for placing and retaining front dashboard mat 120 onto the dashboard surface. In this case, front dashboard mat 120, with evaporate layer 122 and finished edge 124 incorporates a high strength magnet 128 into the material of the layered mat, either within the layers or above or below the layers. In a preferred embodiment magnet cover 130 is sealed against the mat layers from below to position magnet 128 appropriately on either end of the length of the mat (in approximately the same positions as the grommets described above). Instead of positioning a retention post on the dashboard, the user would position a metal plate 126 (such as a steel rectangular plate) adhesively onto the dashboard surface. Modern magnet technologies provides very strong magnets in relatively small sizes that will more than adequately retain the mat of the present invention, with fluid incorporated into the evaporative layer, securely on top of the front dashboard of a motor vehicle.

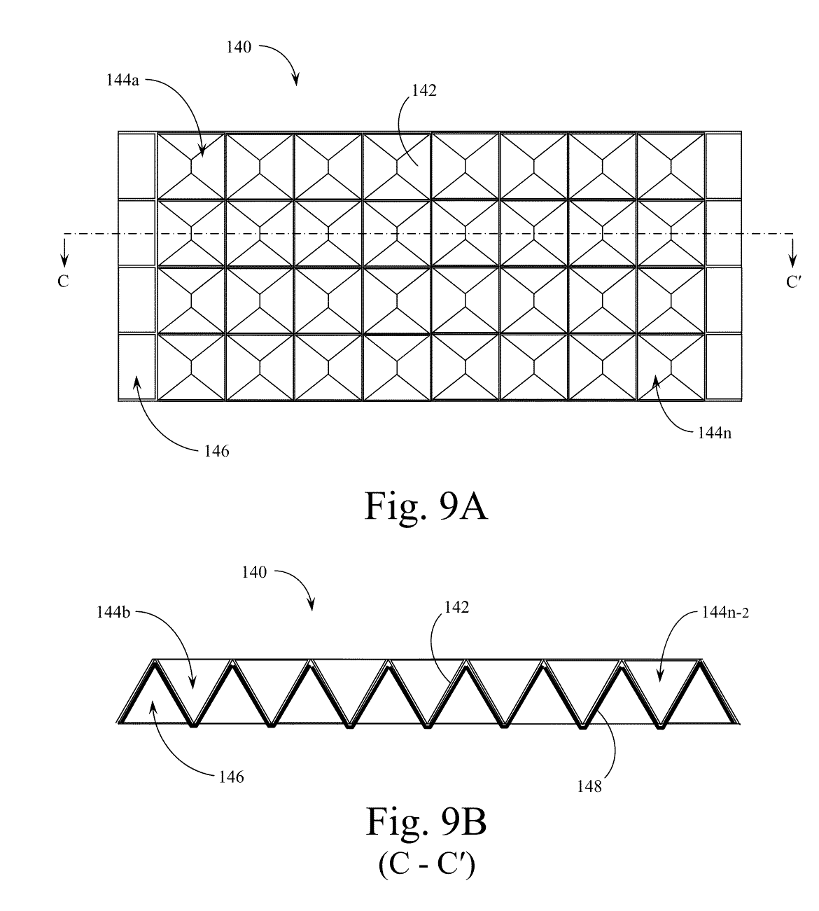

While the various structures described above are designed for use primarily in conjunction with the front dashboard of a motor vehicle, they do also lend themselves to use on the rear window shelf of most automobiles. An alternate structure, however, shown in FIGS. 9A & 9B may be preferable for implementation on the rear window shelf. Because such rear window shelves frequently incorporate speaker systems, it may be desirable to provide a smaller (shorter in length) mat structure that is expandable to the user's specific requirements. FIG. 9A is a top plan view showing a specially formed sheet of material configured with a regular array of folded or formed compartments that serve to increase the surface area available for evaporation and to retain more significant quantities of fluid, all within a smaller surface area on the rear window shelf. The sheet of material may be similar to that utilized in conjunction with the front dashboard environmental moderator, generally comprising any of a number of pressed fiber materials that are able to retain significant quantities of fluid and to provide, by way of the fibrous surface areas, extensive surfaces from which the fluid may evaporate. Rear window mat 140 shown in FIG. 9 is generally comprised of evaporative sheet material 142 that is folded or formed into egg crate like compartments 144a-144n. On either end of the array of compartments thus formed are support compartments 146.

The sheet material 142 utilized in the embodiment shown in FIG. 9A may be formed by press molding the sheet into the structure shown, or may be formed by what is known as tessellation. Such tessellated sheets are known for use as acoustic dampening surfaces as well as structural support surfaces. Reference is made to U.S. Pat. No. 7,762,938 as one example of an appropriate structure, and method for producing, the tessellated mat of the rear window component of the system of the present invention. Other structures and methods are likewise appropriate for creating this array of compartments from the layered mat sheet material of the present invention.

FIG. 9B shows a longitudinal cross sectional view of rear window mat 140 taken along section line C-C′. In this view the structure of retention modules 144b-144n are more clearly seen. Formed from the layered combination of the evaporative material 142 and fluid impermeable material 148 into the individual cups shown in cross section, the rows of modules 144 are supported on either end by support structures 146 made of the same materials. Alternately in this design, it possible to water proof only a portion of the underside of evaporative material 142 as only the lower points of the folded compartment might require surfacing with the fluid impermeable layer 148.

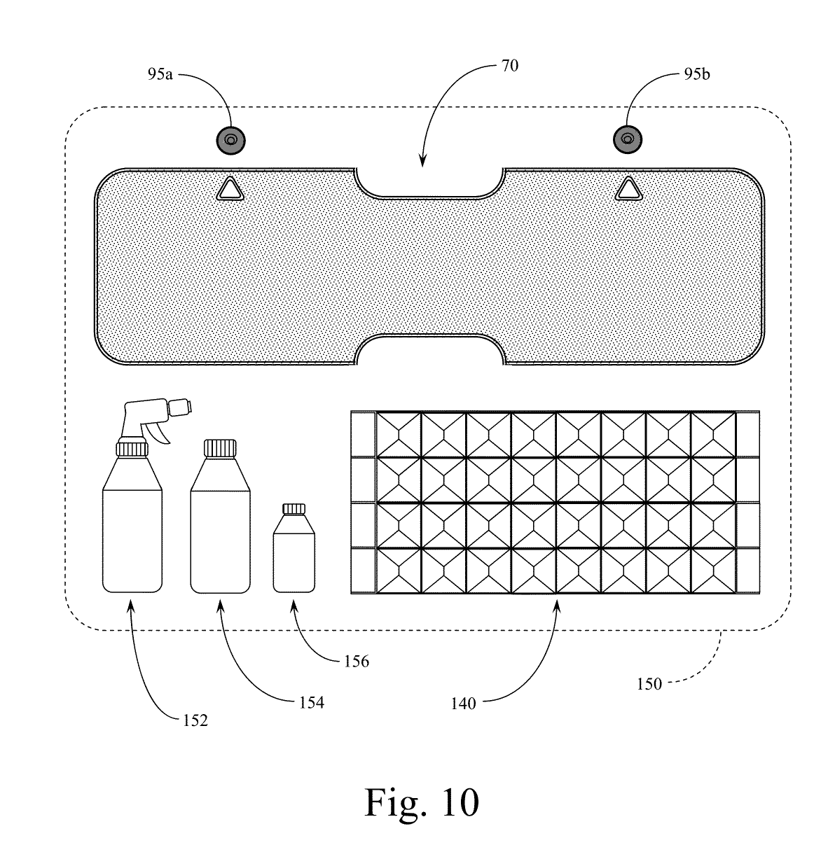

Reference is next made to FIG. 10 for a brief description of an assembly of components that may be sold as a kit for implementation of the system of the present invention within a single motor vehicle. In this assembly kit 150, front dashboard component 70 is provided along with rear window shelf mat 140. Retention posts 95a & 95b are provided for use with front dashboard mat 70. Various fluids and application containers are also provided within kit 150. Spray bottle 152 is intended for use with front dashboard mat 70 primarily, although it may be utilized in conjunction with rear window mat 140 as well. Fluid container 154 provides a manner of pouring larger quantities of fluid into the larger volume rear window mat 140. Both containers 152 & 154 may be sold within kit 150 with either purified water or purified water containing antimicrobial (antibacterial and/or antifungal) compounds. While it is anticipated that both the front dashboard mat and the rear window shelf mat may be removed and cleaned on a regular basis it is preferable that the fluids utilized should already contain some compounds that prevent the buildup of undesired microbes within the permeable surface structures of the mats. In addition to the antimicrobial compounds, kit 150 preferably also includes a small amount of fragrance compound 156 that may be mixed in with the fluid compounds contained in spray bottle 152 and/or pouring container 154.

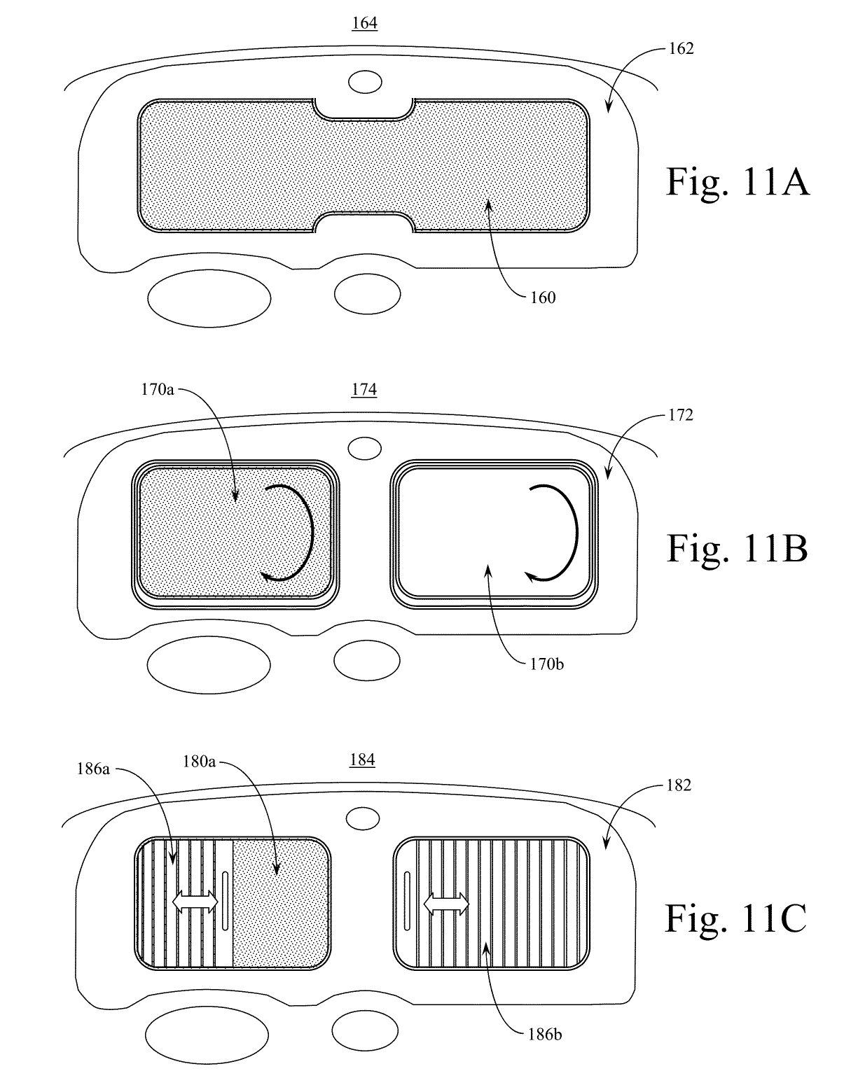

Reference is finally made to FIGS. 11A-11C for a brief description of various embodiments of the present invention that may be manufactured into the dashboard of a motor vehicle as original equipment. FIG. 11A shows dashboard 162 with environmental moderator mat 160 permanently fixed onto or recessed into the top surface of the dashboard, in position below windshield 164. FIG. 11B shows dashboard 172 with two reversible environmental moderator mat panels 170a & 170b removably positioned within recessed holders on the top surface of the dashboard, again in position below windshield 174. Finally, FIG. 11C shows dashboard 182 with two recessed environmental moderator mat panels 180a & 180b fixed in position on the top surface of the dashboard, again in position below windshield 184, but in this case covered by slidable covers 186a & 186b that allow the user to open or close off the mat function.

Although the present invention has been described in conjunction with a number of preferred embodiments, those skilled in the art will recognize modifications to these embodiments that still fall within the scope of the present invention. Because of the standardized size of a motor vehicle dashboard such as utilized in the present invention, the dimensions may be structured as simply small, medium, and large, or may accommodate folding of the ends of the mat. Alternately, the present invention may be implemented through the manufacture and sale of custom produced sizes. Multiple smaller pads may be positioned together to cover a larger or discontinuous dashboard or window shelf area.

I claim:

1. A device for moderating the temperature and humidity of the air inside a motor vehicle, the motor vehicle having a dashboard and/or a rear window shelf, the device comprising:
(a) a fluid wicking layer of material formed into a generally flat non-rigid pad, sized to fit on the top surface of the dashboard and/or rear window shelf; and
(b) a fluid impermeable layer of material sized to generally cover and underlay the fluid wicking layer of material of the flat non-rigid pad the pad;
whereby an evaporative fluid may be placed into the wicking layer of material where it may evaporate into the surrounding air by solar heating experienced through the windshield and/or the rear window of the vehicle, thereby moderating both the temperature and humidity of the interior of the vehicle.
